(19) United States
(12) Patent Application Publication
(10) Pub. No.: US 2012/0287691 A1
(43) Pub. Date: Nov. 15, 2012

(54) Battery Substitute Device For Power Tools

(76) Inventor: Edward Louis Breuner, San Ramon, CA (US)

(21) Appl. No.: 13/103,176

(22) Filed: May 9, 2011

(51) Int. Cl. H02M 1/00

(52) U.S. Cl. 363/146

(57) ABSTRACT

A battery substitute device for providing an alternative power source for battery operated ‘cordless’ tools and similarly powered appliances. The battery substitute device is generally shaped like the battery pack it replaces and includes an AC-DC power converter powered by AC plug-in power through a flexible line and AC mains plug. The battery substitute device interchangeably mates with said tools and appliances providing the option of continuous uninterrupted, full power use of the tool and gives the user the option of optimized power source for material, torque and power properties, and user convenience. The battery substitute device reduces the need for multiple battery packs, extends the life of the battery packs and reduces waste caused by fully depleted battery packs. It also reduces the need to anticipate a project and charge battery packs. The battery substitute device will make a useful, effective tool much more useful and much more effective.

### FEDERALLY SPONSERED RESEARCH

Not Applicable

### SEQUENCE LISTING OR PROGRAM

Not Applicable

### FIELD OF THE INVENTION

The present invention generally relates to a power supply device for cordless power tools and appliances. More particularly, to a battery pack shaped AC power supply which functions as a battery replacement for portable hand-held battery powered (“cordless”) power tools and appliances.

### BACKGROUND OF THE INVENTION

Batteries have become a common power source for many devices such as flashlights, cameras, radios, computers and power tools. Although many devices are designed for both battery power and external power, some devices are still manufactured with only battery capability. Low-draw battery powered devices, such as cameras and flashlights, often have fixed, internal batteries that are recharged in the device or have replaceable, industry-standard sized batteries. High-draw battery powered devices, such as portable cordless power tools, often have removable, rechargeable battery packs that are inserted into a cavity in the device.

Battery powered cordless power tools allow the tool to be used where AC power is not available, however battery power has many drawbacks. The charge capacity, the speed of recharge and the availability of additional battery packs limit the use of the tool. Batteries have a limited lifetime and the more often and the faster the batteries are recharged, the shorter the effective lifetime. As batteries are depleted during use, the tool speed and effectiveness is also reduced. Batteries, when fully depleted, are an environmental hazard when discarded or improperly recycled. Replacement batteries and fast chargers are expensive.

Prior art has recognized the need for a battery replacement device, but has not been designed for ease of use in the normal working environment or by many of the common power tools. In some cases, there are in-line connectors, sometimes multiple connectors between the DC output terminus and the AC input terminus. In-line connectors are additional locations to unintentionally disconnect from the power source during work, and wear and contamination will increase the incidence of disconnect.

In some cases there are large, relatively heavy electrical housings in the middle of the power cord or at the AC terminus, which would cause unintentional disconnect from the power source during work. A heavy, swinging housing could dangerously pull the tool out of alignment and could be more easily damaged than a housing attached to the tool.

### SUMMARY OF THE INVENTION

The invention is a battery substitute device that will dramatically increase the usability of ‘cordless’ power tools.

Briefly put, when the tool is used where an external source of energy is available, my invention permits the tool's power to be supplemented from plug-in AC power. This has the advantage of a tool that can be used while recharging its batteries. Additionally during demanding power tool usage that requires the tool to be operated up to full rated driving torque, the battery substitute device using AC power allows continuous uninterrupted, full power use of the tool. In this manner the tool and power source can be optimized for material, torque and power properties, and user convenience.

The battery substitute device consists of an AC cord plug and a flexible power cord running from the AC cord plug to an AC-DC rectifier in the general shape of the tool's exchangeable battery pack and designed and sized to fit into the recess in the tool normally filled by its battery power pack.

Due to the different sizes and shapes of the battery packs used by the different power tool manufacturers, the battery substitute device is required to have an equal number of body shapes and sizes, and connector configurations.

Use of the battery substitute device provides several benefits; (a) it allows continuous full power use of the tool, (b) it allows unscheduled use of the tool, (c) it reduces frequent battery pack changes and recharging during power demanding tool usage, (d) it decreases the use of battery energy which will extend the rechargeable life of the batteries also creating less environmental problems caused by disposal of unusable batteries, and (e) it reduces the requirement for purchasing additional chargers and multiple battery packs due to demanding battery pack usage and charging time.

The principle objective of the invention is to provide an alternate power source for a battery-operated tool that is simple to manufacture, simple to use and improves the usefulness of the tool while reducing its operating cost.

### BRIEF DESCRIPTION OF THE DRAWINGS

FIG. 1 is a perspective view of a “cordless” power tool with a common battery-pack inserted in its handle.

FIG. 2 is a perspective view of a “cordless” power tool with a battery replacement device inserted in its handle.

FIG. 3 is a perspective view of a battery replacement device representing the present disclosure.

FIGS. 4, 5, and 6 show representations of DC terminus connectors.

### DETAILED DESCRIPTION

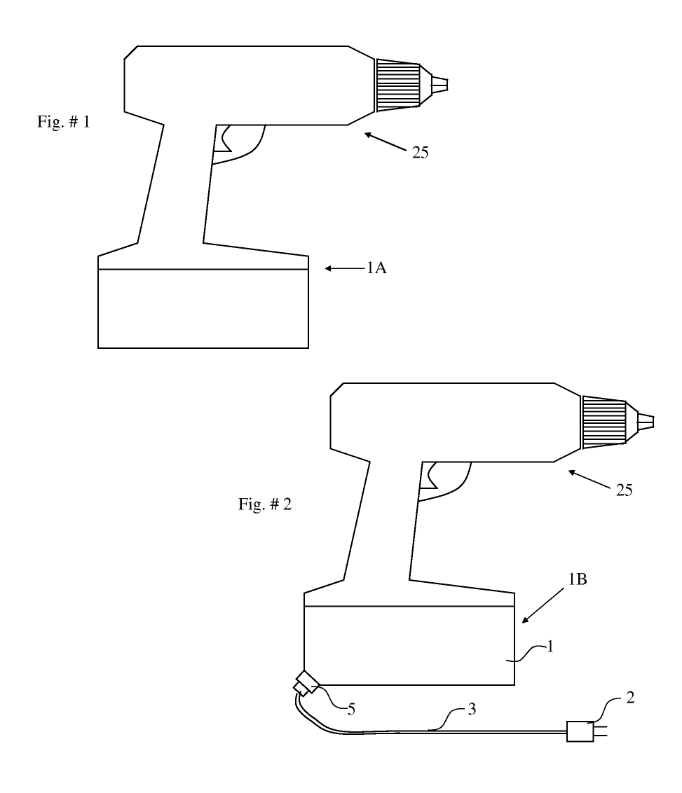

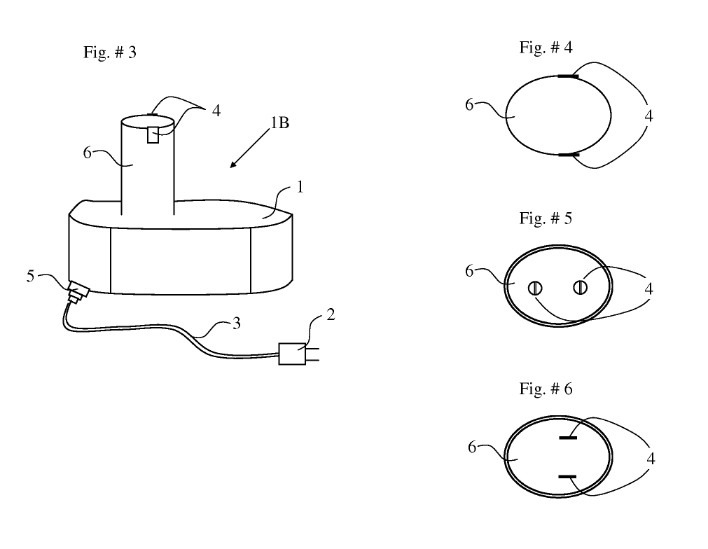

The present invention is directed to an AC power supply for battery powered portable tools and appliances. Common battery powered portable tools are powered by relatively low voltage DC motors (not shown) and energized by rechargeable battery packs 1A from 12 volt or less to 24 volts or more depending on the type of tool and application. Common battery powered appliances which use identical battery packs include flashlights and radios. FIG. 1 displays a replaceable battery-pack 1A powered (“cordless”) drill 25, shown as an example, and could be a reciprocating saw, a circular saw, screwdriver, hammer drill, jig saw, line trimmer, blower, vacuum or any other similarly designed portable “cordless” tool or appliance. FIG. 2 displays a battery replacement 1B powered (“cordless”) drill 25, shown, as an example, and could be a reciprocating saw, a circular saw, screwdriver, hammer drill, jig saw, line trimmer, blower, vacuum or any other similarly designed portable “cordless” tool or appliance. FIGS. 1 and 2 show both power sources attached to the tool, inserted into the tool handle as is common. FIG. 2 shows the battery replacement device 1B embodied in the present disclosure inserted into the tool handle. FIG. 3 is a perspective view of the battery replacement device as embodied in this disclosure. The body of the device is shaped like the appropriate battery pack for the desired tool. Instead of a battery, the main part of the body 1 holds an AC/DC converter that converts 120 volts AC into DC at the appropriate power requirement for the desired tool. The battery replacement device 1B plugs into a common 120 volt AC source using a common AC mains plug 2. The insertion shaft of the body 6 is inserted into a cavity in the tool designed to hold a battery pack (commonly in the handle) and the power flows from the AC power source through the mains plug 2, along the flexible power cord 3 into the AC/DC converter where it is converted to DC and powers the tool through electrical contacts 4 that are located near the end of the insertion shaft portion of the body 6. The power cord 3 is supported as it enters the body 6 by a flexible, non-conducting stress reliever. FIGS. 4, 5, and 6 show three locations and configurations of said electrical contacts on the end of the insertion shaft.

There are many types of portable battery powered tools and each tool is different in design and power requirements. It is therefore to be understood that that the foregoing embodiment of the disclosure has been presented for purposes of illustration and explanation and is not intended to limit the disclosure to a specific configuration.

What is claimed is:

1. A device for providing DC power for a tool or appliance designed to be powered by a removable battery, which fits into a recess in the tool comprising:
a battery shaped housing that is configured to removably mate with a specified tool or appliance and having terminals for providing electrical communication with said tool or appliance,
a power converter within said battery shaped housing adapted to convert AC power to the specific DC power requirements of said tool, a stress relieved flexible cord with an AC mains plug.

2. The device as defined in claim 1, wherein said housing is sized to generally correspond to the size and shape of the battery pack used in specific power tools or appliances.

3. The device as defined in claim 1, wherein said power converter is adapted to be plugged into and powered by an AC power source.

4. The device as defined in claim 1, wherein said housing has positive and negative terminals for providing electrical communication with said tool or appliance, said positive and negative terminals being located at the end of the insertion shaft of the housing.

6. The device as defined in claim 1, wherein said power converter is adapted to convert AC power to the specific DC power requirements of said tool.
